(19) United States
(12) Patent Application Publication
(10) Pub. No.: US 2009/0114322 A1
(43) Pub. Date: May 7, 2009

(54) TREAD MARKER, TIRE WITH INTEGRAL TREAD MARKERS, AND METHODS FOR PRODUCING BOTH

(76) Inventor: Pat O'Brien, Portland, OR (US)

Correspondence Address: Stolowitz Ford Cowger LLP, 621 SW Morrison St, Suite 600, Portland, OR, 97205, US

(21) Appl. No.: 12/265,924

(22) Filed: Nov. 6, 2008

Related U.S. Application Data
(60) Provisional application No. 60/985,969, filed on Nov. 6, 2007.

(51) Int. Cl. B60C 11/24; B29C 47/00; B29C 65/06; B32B 37/00

(52) U.S. Cl. 152/154.2; 156/244.18; 156/73.5; 156/293

(57) ABSTRACT

Disclosed are several embodiments of a colorized tread marker for a tire, a method of manufacturing the tread markers, as well as a tire incorporating the colorized markers within the tire tread and a method for manufacturing the tire. The tread markers serve as both aesthetic complements to the tires' visual appearance, such as indicia of the source of manufacture, distribution, or point of consumer purchase of the tire, as well as tread wear indicators that notify consumers when a tire is in need of replacement to help ensure the safety of a vehicle's occupants as well as the public at large.

### RELATED APPLICATION DATA

This application claims priority from U.S. provisional application Ser. No. 60/985,969 filed Nov. 6, 2007, that we incorporate by reference.

### FIELD OF THE INVENTION

The present invention relates to tread markers for tires and tires that incorporate such markers.

### BACKGROUND OF THE INVENTION

The automobile is the most prevalent form of transportation. As the only point of contact between a speeding automobile and the roadway, pneumatic tires play a critical role in helping to ensure the safety of both a vehicle's occupants, as well as the safety of others who share common roadways. The tread of a tire is designed to provide traction under a variety of road conditions including wet roadways as well as slush-filled, snow-covered, and icy roadways. When tire tread wears thin, the tractive capacity of the tire is diminished to a point where the tires should be replaced. This occurs through the normal wear of tires, but can also occur, often in an accelerated manner, in the uneven wear of tires which are, for example, out of alignment, out of balance, or over/under inflated. Consequently, preventive maintenance by vehicle owners, such as keeping the tires in alignment, balanced, and properly inflated, can extend the tire's useful life while protecting a vehicle's occupants and others.

Even though tires are so critical to people's safety, the condition of tires on an automobile is often overlooked by the busy owner. This is because tire tread is homogeneously colored and looks, at a glance, the same—day in and day out. This is compounded by the fact that tire makes and models, for the most part, look the same across the tire-making industry. Consequently, tires are commodity items in the mind of the consumer.

What is needed is a tire that elevates the status of this critically important component of the automobile by grasping consumers' attention while providing consumer value through the incorporation of tread wear indicators within the tire's tread. What is needed is a visually attractive tire whose tread contains an eye-catching logo, icon, trademark, or indicia of the source of manufacture, distribution, or point of consumer purchase while providing a continuous visual indication of the tire's wear status so that the consumer is able to discern, at a glance, the level of performance and safety he or she can expect from his or her tires. Furthermore, it would be of benefit to visually ascertain tire tread wear from a distance, not only when the vehicle is stationary, but also when it is moving, and to achieve these objectives in a cost effective, practical manner.

The present disclosure solves many of the disadvantages associated with existing tires by providing insertable tread markers, tires containing insertable tread markers, as well as methods of making the tread markers and tires incorporating them. It will be appreciated that the disclosure may disclose more than one invention. The inventions are pointed out with particularity in the claims annexed hereto and forming a part hereof.

### BRIEF DESCRIPTION OF THE INVENTION

The inventions generally relate to tread markers that are inserted into the tread of a tire, methods of making the tread markers, tires that incorporate the tread markers, and methods of manufacturing the tires. The tread markers may be multicolored to provide a visual indication of the level of wear at a particular location in the tire. A change in color of the tread marker, as viewed by a consumer as a tire's tread wears, may particularly indicate when a tire is approaching the end of its effective life, has reached the end of its effective life, or it may indicate a percentage of the tire's life expended or remaining. In addition, the marker may be used to indicate an end of a warrantee, or an end of a certain level of safety for a particular type of road condition, such as wet or icy or snowy roadways, for example. The tread markers may also display a popular icon or symbol, or provide indicia of the source of manufacture, distribution, or point of purchase of the tire, e.g., by including a logo, trademark, or other indicia of source. Preferably, multiple tread markers are located in the tread, both radially around the circumference of the tire, as well as in a direction parallel to the tire's axis, between the two shoulders of a tire.

A first embodiment of the tread marker comprises a top portion having a first color, and a bottom portion having a second color, where the marker is adapted to be mounted in a blind hole in the tire tread at a predetermined depth, where the first color substantially matches a color of the tire tread, and where the second color is configured to provide an indication that the tire has reached a tire replacement time.

A second embodiment of the tread marker comprises a body having an axis, a top surface, and a bottom surface, where the body comprises a multicomponent stack along the axis, where each component includes a color different from adjacent components.

A third embodiment of the tread marker comprises a rod-shaped polymeric body having an axis, a top surface and a bottom surface; a first wear region within the marker having a first color and located axially from the outer surface to an interface that is perpendicular to the axis, where the first wear region provides an indication of a percentage of tread life expended as the marker wears from the top surface to the interface, and a second wear region having a second color and located below the interface, where the second wear region provides a visual indication that a tire replacement time has been reached.

A fourth embodiment of the tread marker comprises a rod-shaped polymeric body having an axis, a top surface and a bottom surface; a first wear region within the marker having a first color and located axially from the outer surface to an interface that is perpendicular to the axis, where the first wear region includes a popular icon or symbol or indicia of source of manufacture, distribution, or point of purchase, and a second wear region having a second color and located below the interface, where the second wear region provides a visual indication that a tire replacement time has been reached.

A fifth embodiment of the tread marker comprises a rod-shaped polymeric body having an axis, a top surface and a bottom surface; a first wear region within the marker having a first color and located axially from the outer surface to an interface that is perpendicular to the axis, where the first wear region provides a popular icon or symbol, or indicia of source of manufacture, distribution, or point of purchase, as well as a visual indication of a percentage of tread life expended, as the marker wears toward the interface, and a second wear region located below the interface having a second color, where the second wear region provides a visual indication that a tire replacement time has been reached.

One advantage of the present apparatus is that it provides consumers with an eye-catching indication of the wear status of his or her tires, to notify him or her that a tire is in need of maintenance, or that the end of the tire's effective life is approaching or has passed.

Another advantage of one embodiment is that it elevates the status of the tire from that of an ignored commodity to one where consumers are able to differentiate one brand from another and choose the brand that provides an inherent level of safety by providing an instantaneous indication of tread wear, and indicating in a visually obvious manner when the effective lifetime of the tire is over.

The inventions are pointed out with particularity in the claims annexed hereto and forming a part hereof.

### BRIEF DESCRIPTION OF THE DRAWINGS

FIG. 1 is a side view of a tire having a section removed so as to provide a section view of the tread of the tire having visually indicating tread markers in accordance with the invention.

FIG. 2 is an enlarged section view of a portion of FIG. 1.

FIG. 3 is an end view of the tire of FIG. 1, showing an exemplary placement of visually indicating tread markers in the tread of the tire.

FIGS. 4A-B are two isometric views of a first embodiment of a tread marker.

FIG. 4C is an exploded view of the first embodiment of a tread marker.

FIGS. 5A-C are lateral sectional views of the first embodiment of a tread marker.

FIG. 5D is a longitudinal cross section of the first embodiment of a tread marker.

FIGS. 6A-C are sectional views of a second embodiment of a tread marker.

FIG. 6D is a longitudinal cross section of the second embodiment of a tread marker.

FIGS. 7A-C are sectional views of a third embodiment of a tread marker.

FIG. 7D is a longitudinal cross section of the third embodiment of a tread marker.

FIGS. 8A-C are a top view, a side view, and a lateral sectional view of a fourth embodiment of a tread marker.

FIGS. 9A-B are a top and a side view of a fifth embodiment of a tread marker.

FIGS. 10A-B are a top and a side view including partial sectional views to show an embodiment of an interface between two annular components of the fifth embodiment of a tread marker.

FIG. 11A-F shows exemplary arrangements of tread markers in a tire tread which yield visually attractive tread marker patterns both when a vehicle having such tires is stationary, as well as when it is moving.

### DETAILED DESCRIPTION

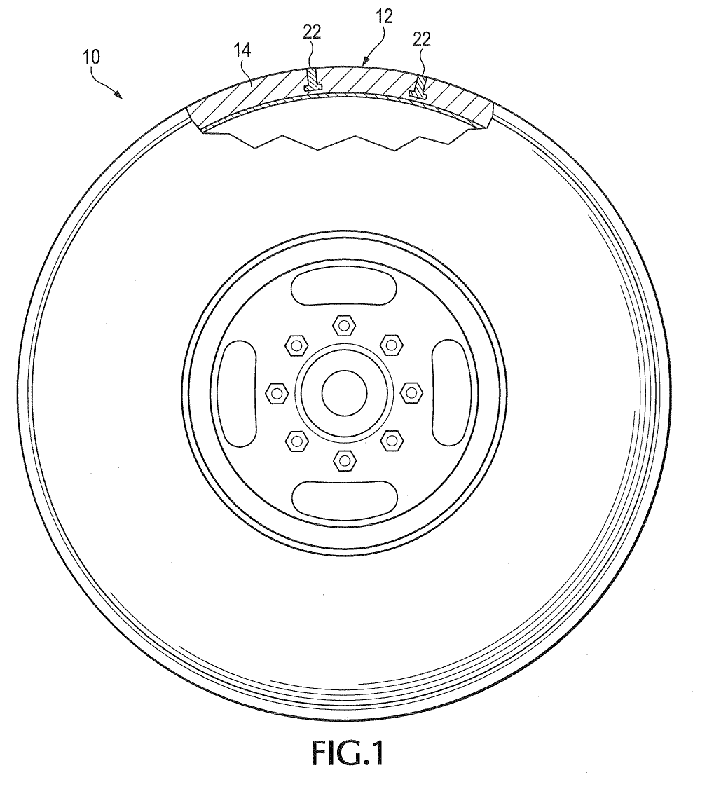

In the drawings like reference numerals generally designate identical or corresponding parts throughout the several views. Referring to FIGS. 1-3, there are shown illustrations of a tire showing exemplary locations of tread markers 22 in the tread of a tire. In particular,

FIG. 1 illustrates a vehicle tire 10 with a portion of the tire wall removed as indicated by reference 12. Tread markers are distributed both radially around the perimeter of the tire, as well as across the width of the tire (as shown in FIG. 3).

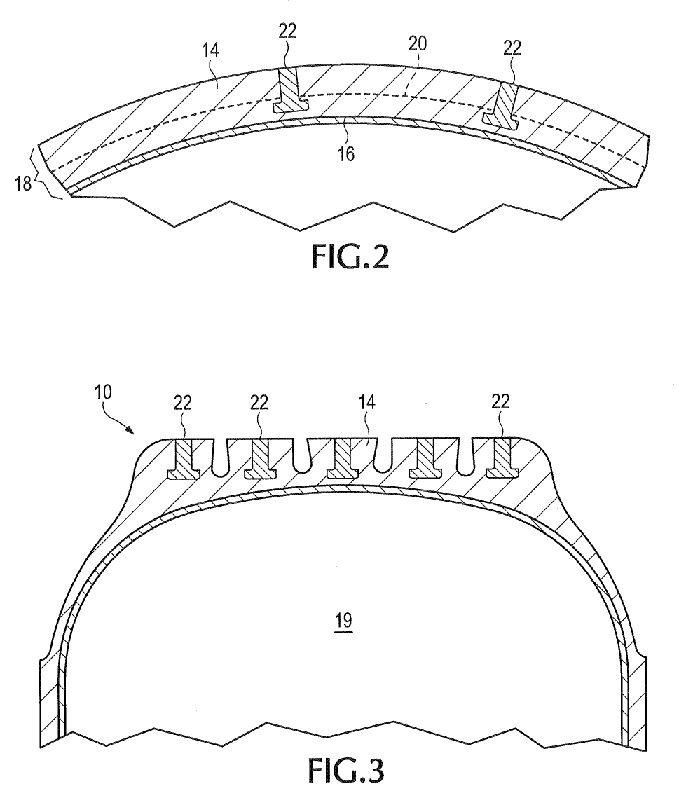

FIG. 2 shows partial sectional view 12 at a magnified scale. Wall portion 18 is in general made up of a casing 16 and tread 14 that is secured to the casing by vulcanization, a process well known to the industry. In general, the “end of life” of a tire is reached when the tread 14 wears down to a pre-determined minimal thickness, which is indicated in the drawings by dashed line 20. Also shown is an exemplary placement of a tread marker 22 relative to the end of life 20 of the tire.

To manufacture a tire that will have tread markers 22 inserted, the following process is used. A casing and uncured rubber compound components are inserted into a tire mold, heated and pressurized. After vulcanization of the rubber occurs, the mold and tire are cooled to a temperature that provides the tire with mechanical properties sufficient for removal from the mold without damage. The outer diameter of the tire mold, in addition to having metal tread inserts, which form the surfaces of the treads, includes a plurality of generally cylindrically shaped metal inserts that extend radially from the tread's outer surface inwardly to a predetermined depth toward the central axis of the tire. (Other shapes could be used, particularly if the tread markers have non-circular cross sections.) These cylindrical mold inserts, when removed from the cured tire, form blind holes in the tread (not shown). The number and placement of the cylindrical inserts corresponds to the desired number and placement of tread markers 22 in the finished tire, as shown, for example in FIGS. 1-3 and 11. The diameter of the blind holes are smaller than a width of the tread markers so that the markers are held in place by compressive stresses imposed on the tread markers by the surrounding rubber tread. Many of the enclosed embodiments of the tread markers may be inserted with standard stud insertion tools, or stud guns, which insert spreader fingers into the blind hole, expand it, insert the tread marker 22, and release the blind hole. Stud guns are available, for example, from Bruno Wessel at www.brunowessel.com, or OKU Automatik, OKU, of Germany at http://www.oku.de/index.html?uk/produkte/Spikes/einsetzpistolen/navigationpkw.html.

FIG. 3 illustrates an end view of the vehicle tire 10 showing an exemplary tread pattern 19 in the tread 14. A portion of the tire wall has been removed to show an exemplary placement of tread markers 22.

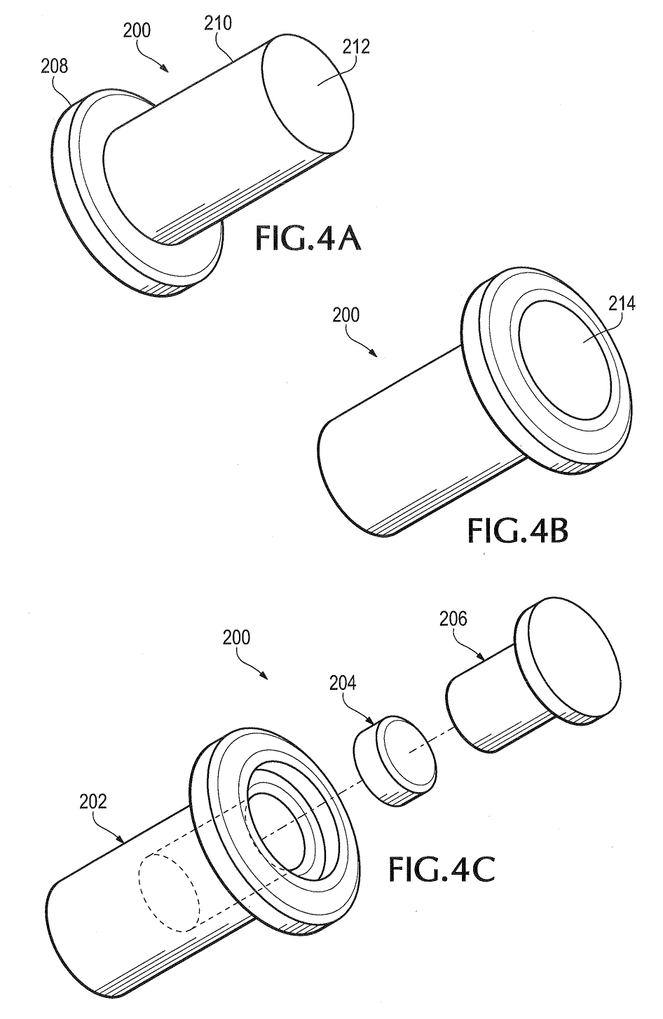

FIGS. 4-10 illustrate several embodiments of tread markers to be used in tires, and are shown, rather than in the context of sectional views through a tire, as the tread markers by themselves. Each illustrated embodiment of a tread marker has a generally cylindrical outer shape, having generally circular lateral cross sections. However, other cross sectional geometries, for example oval, elliptical, square, rectangular, triangular, and the like, are contemplated and could easily be substituted for those illustrated.

Referring now to FIGS. 4A-B there is shown a first embodiment of a colorized tread marker designated generally by the numeral 200. The tread marker 200 has a head portion 208, a body portion 210, an outer surface 212, and an inner surface 214. The head portion 208 of the tread marker 200 is generally of a larger diameter than the body portion 210 and, once installed, helps prevent the tread marker from dislodging from the tire and additionally helps distribute the vehicle load, which may be transferred through the outer surface 212 from the roadway. FIG. 4C shows an exploded view of tread marker 200. The tread marker 200 comprises a jacket 202, a disk 204, and a plug 206. The three components may be made from several types of materials including, for example, thermoplastics such as nylons, polyolefins, thermoplastic rubbers, or acrylonitrile butadiene styrene (ABS), or other polymers such as polyolefins, polyurethanes, or natural or synthetic rubbers, or combinations thereof. Each component may be formed through such processes as molding, for example to injection molding, compression molding, transfer molding, casting, extrusion, or the like. In one embodiment, the chosen material for the tread marker, in use, should wear away at a rate similar to or greater than that of the surrounding tread. The color of the material used in each of the three components may be the same, however, it is preferred that each component be a different color. In this embodiment an example color scheme is one where the jacket 202 is black and matches the surrounding tire tread, the disk 204 is yellow or white, and the plug 206 is red. The three components nest together and may be fused together by means well known in the art such as ultrasonic welding or through the use of adhesives or friction.

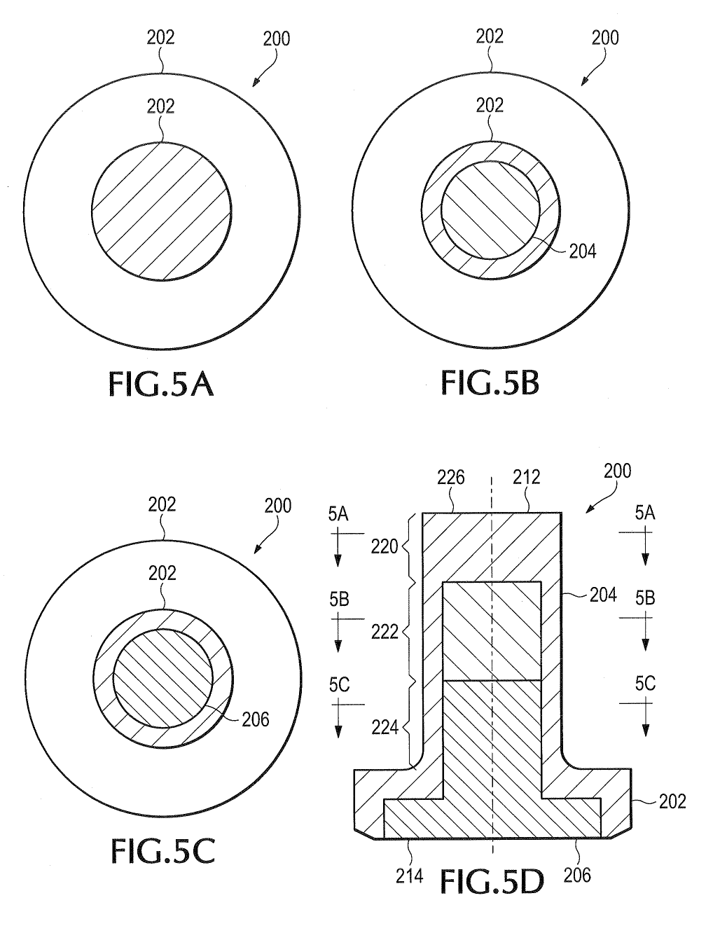

FIG. 5D is a longitudinal cross section of the first embodiment of a tread marker 200 showing the relations between the three components. FIGS. 5A-C are lateral cross sections that show how the tread marker's wear surface looks to a consumer at various stages of wear. The wear surface 226 initially starts at the tread marker's outer surface 212, and progressively moves toward the tread marker's inner surface 214 as the tire wears.

In use, as the tread marker 200 wears away along with the tire tread 14 (FIG. 1), this embodiment has three distinctive wear regions (220, 222, and 224) as shown in FIG. 5D. When a tire having these tread markers is first used, wear occurs in the first wear region 220. This initial wear region is depicted in FIG. 5A, section A-A. The consumer would see the cross hatched section shown of each tread marker located around the perimeter of the tire. When the exemplary color scheme is used, the tread marker is not readily apparent to the consumer in the first wear region 220, since the color of the jacket 202 of the tread marker 200 matches the black of the surrounding tread 14 (FIG. 1).

After a significant level of tread wear has occurred, the second wear region 222 is reached as shown in FIG. 5D. The consumer sees crosshatched circular areas, as shown in FIG. 5B, section B-B. When the exemplary color scheme is used, the consumer will be alerted to a tire that is becoming worn when he or she sees a circular yellow (or white) area corresponding to disk 204 appearing on the tread of the tire. The yellow circular areas may also serve to indicate to the consumer that preventive maintenance should be undertaken or is recommended. For example, if the yellow areas are appearing toward one shoulder of a tire and not the other, uneven tire wear is occurring, and wheel alignment, balancing, or tire pressure adjustment should be performed to both increase the life of the tire, as well as provide a greater level of safety to the consumer.

As the tire reaches the end of its effective life, the third wear region 224 is reached, as shown in FIG. 5D. The consumer sees the crosshatched circular areas, as shown in FIG. 5C, section C-C. When the exemplary color scheme is used, the consumer will be alerted to a tire that is becoming worn when he or she sees bright red circular areas corresponding to plug 206 on the tread of the tire. At this point the tire is in need of replacement.

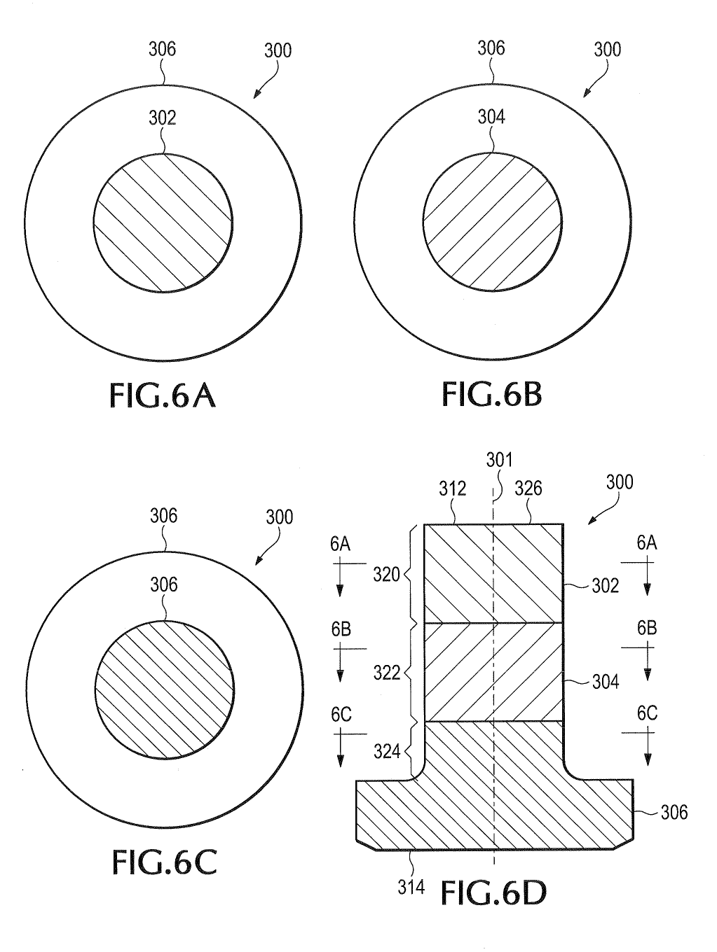

FIG. 6D is a longitudinal cross section of a second embodiment of a tread marker. As with the first embodiment, each component has rotational symmetry with the tread marker longitudinal axis (here axis 301). The second embodiment comprises components configured generally in a stack. Three components are shown here, though any number could be used. Here, for exemplary purposes, there is shown a thread marker 300 comprising a top piece 302, a middle piece 304, and a base 306. FIG. 6 shows the relations between the three components, along with lateral cross sections (FIGS. 6A, 6B, and 6C) that show how the tread marker's wear surface looks to a consumer at various stages of wear. The materials and construction of this embodiment of a thread marker are similar to that mentioned above with respect to a first embodiment, as is the exemplary color scheme of black-yellow(or white)-red. Also similar to the first embodiment, wear surface 326 initially starts at the tread marker's outer surface 312, and progressively moves toward the tread marker's inner surface 314 as the tire wears.

In use, as the tread marker 300 wears away along with the tire tread 14 (FIG. 1), this embodiment also has three distinctive wear regions (320, 322, and 324). When a tire having these tread markers is first used, wear occurs in the first wear region 320, and is visible to a consumer as the cross hatched area of FIG. 6A, section A-A. When the exemplary color scheme is used, the tread marker is not readily apparent to the consumer in the first wear region 320, since the color of the top piece 302 of the tread marker 300 matches the black of the surrounding tread 14 (FIG. 1).

After a significant level of tread wear has occurred, the second wear region 322 is reached, and is visible to a consumer as the cross hatched area of FIG. 6B, section B-B. When the exemplary color scheme is used, the consumer will be alerted to a tire that is becoming worn when he or she sees yellow or white circular regions appearing on the tread of the tire. As in the first embodiment, the yellow circular regions may also serve to indicate to the consumer that uneven tire wear is occurring and that preventive maintenance such as wheel alignment, balancing, or tire pressure adjustment should be made to both increase the to life of the tire, as well as provide a greater level of safety to the consumer.

As the tire reaches the end of its effective life, the third wear region 324 is reached, and is visible to a consumer as the cross hatched area of FIG. 6C, section C-C. When the exemplary color scheme is used, the consumer will be alerted to a tire that has reached its end of life when he or she sees bright red circular areas that have replaced the yellow (or white) circular areas on the tread of the tire. At this point the tire is in need of immediate replacement.

In a related embodiment, the tread marker material comprises a sensor material, such as a magnetic material within a polymeric matrix, which is progressively worn away. As the sensor material is worn away, the signal level received by a second sensor, such as a Hall-effect sensor, decreases. The sensor material, sensor, a radio-frequency identification (RFID) chip, and a power supply (battery, button battery, or piezoelectric power source, for example) are integrated into a system that transmits the tread wear condition to a receiver in communication with a vehicle's instrument panel to give a readout of the percent life remaining on the tires. In one embodiment substantially all of the system components may be embedded into a tread indicator. For example, the top piece 302 and middle piece 304 of the second embodiment would comprise the sensor material, and the base 306 would comprise the sensor, power supply and RFID chip transmitter.

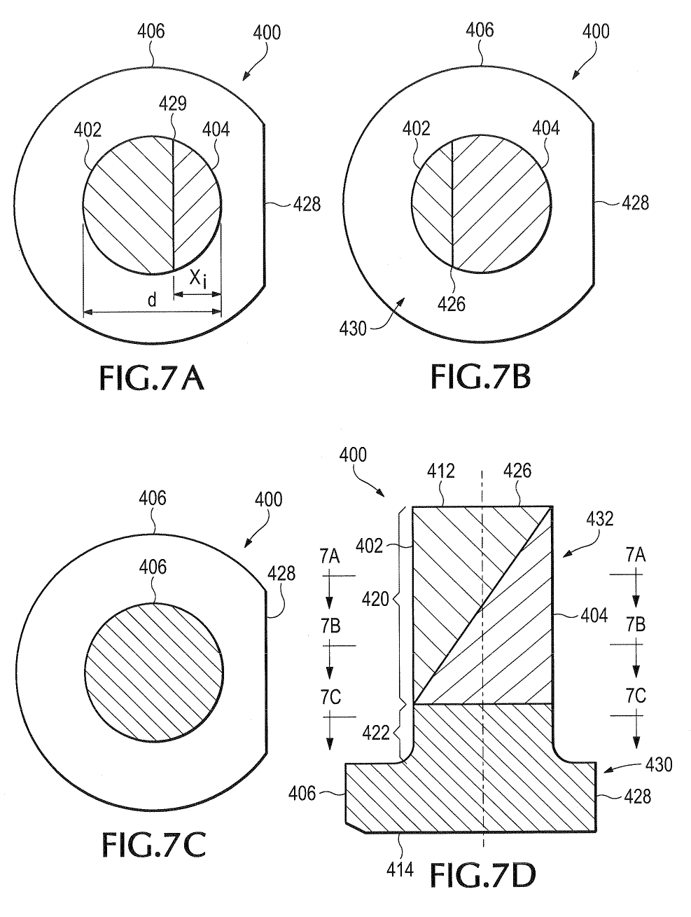

FIG. 7D is a longitudinal cross section of a third embodiment of a tread marker. The third embodiment comprises components that are stacked, but the interfaces between adjacent components may be at angles other than normal to the tread marker axis, to show, for example, the percentage of life spent (or remaining) in the tire's effective life. Alternately, the interfaces between adjacent components, for example between top piece 402 and middle piece 404, could be stair-stepped to yield the same general result, while perhaps providing for more reliable manufacture. Three components are shown here, though any number could be used with multiply angled interfaces therebetween. This embodiment also utilizes a rotational locator feature that is used by assembly equipment to automatically align all of the tread markers inserted into a tire so that they all face the same direction from the perspective of a viewer looking at the tire's outer surface. The rotational locator feature, shown here for illustrative purposes, is a flat portion 428 located on the outside perimeter of the head portion 430 of the tread marker 400. Other rotational locator features located on the head portion 430 or the body portion 432, such as one or more notches or indents, or external features, such as one or more small protruding nubs or fingers, could be used with equal effectiveness.

This embodiment, and subsequent embodiments having rotational locator features, require specialized equipment for the reliable insertion of the tread markers into the blind holes of the tire in an oriented fashion. A customized feed mechanism, such as a magazine, clip, vibratory bowl, linear feed mechanism or the like, is required to align the tread markers prior to their insertion. Such a mechanism may comprise, for example, a clip or magazine similar to those used with semiautomatic or automatic firearms.

Spring loaded box or tubular magazines, having features which align the tread markers, are preloaded with a predetermined number of the tire markers. In addition to supporting the inner surface 414 and/or the outer surface 412, two substantially parallel alignment surfaces are required. One alignment surface butts up against flat portion 428, and the other butts up against the outer diameter of the body portion 432. The distance between the two alignment surfaces is slightly larger than the lateral distance from the flat portion to the diametrically opposed tangent to the outer diameter of the body portion, to allow for the feeding of the tread markers into a stud gun, while preventing misaligned tread markers from fitting into the magazine or clip. The magazine is attached to a stud gun and provides the aligned tread markers to the gun for subsequent aligned insertion.

Alternately, a vibratory bowl into which a plurality of the tread markers are poured may be used, and is more appropriate to a high volume automated assembly operation. The vibratory bowl is adapted to orient the tread markers as they are vibrated from an inner portion of the bowl to an outer perimeter of the bowl where the tread markers exit to the insertion apparatus. Although many means may be used to align the tread markers, an exemplary means is provided herein. The vibratory bowl has a track with a slot slightly larger than the diameter of the body portion 432, but smaller than the large outer diameter of head portion 430 so that the tread markers do not fall through the slot. As the tread markers vibrationally move over the slot, the outer surface 412 falls through a slot and the markers proceed up and around the vibratory bowl. As the tread markers exit the vibratory bowl, all with their outer surface 412 pointing downward, the tread markers proceed down an incline having a similar slot. In addition, above the slot is a perpendicular guide surface running along the slot which touches the large outer diameter of the head portion 430. As the tread markers 400 translate along the slot, the perpendicular guide surface gradually shifts closer to the slot so that the tread markers 400 that initially rotate along their axes as they translate laterally, stop rotating as they translate because the guide surface is located too close to the slot to permit the large outer diameter of the body portion 432 to fit therebetween. The tread markers have now become rotationally aligned with the flat portion 428 located adjacent the perpendicular guide surface. The perpendicular guide surface becomes parallel with the slot at a distance that allows the aligned tread markers to continue translating along the slot without further rotation. The rotationally aligned tread markers are then inserted into the blind holes of the tire in an aligned relation to a tangent of the tire tread to a predetermined depth.

Turning back to FIG. 7A-D, here, for exemplary purposes, there is shown a thread marker comprising a top piece 402, a middle piece 404, and a base 406. FIG. 7D shows the relations between the three components. FIGS. 7A-C show how the tread marker's wear surface looks at various stages of wear. The materials and construction of this embodiment of a thread marker are similar to that mentioned above with respect to a first embodiment, as is the exemplary color scheme of black-yellow(or white)-red. Other colors could be substituted for each component. Also similar to the first embodiment, wear surface 426 initially starts at the tread marker's outer surface 412, and progressively moves toward the tread marker's inner surface 414 as the tire wears.

In use, as the tread marker wears away along with the tire tread, this embodiment has two distinctive wear regions (420 and 422 as shown in FIG. 7D). The first wear region 420 is quite different than those in the previously mentioned embodiments. This embodiment entails a wear region that may be used to give an instantaneous high-resolution indication of the percentage of wear that the surrounding tread has undergone. When a tire having these tread markers is used, wear initially occurs in the first wear region 420. In an embodiment, the location of the wear line 429 gives an indication of the amount of life spent or remaining in the portion of the tread in the immediate vicinity of that marker. More particularly, Xᵢ, shown in FIG. 7A, section A-A, is the location of the wear line 429 relative to the diameter d of the body portion 432 of tread marker 400 gives the percent of a tire's life that has been spent at that location of the tread. This relation is given by the following equation:

% life spent=Xᵢ/d*100

As an example, the wear line in FIG. 7A, section A-A, indicates approximately 33% life spent (Xᵢ is about ⅓ the length of d), and section B-B indicates about 66% life spent (Xᵢ is about ⅔ the length of d).

When the exemplary color scheme is used, the tread markers on a new set of tires are not readily apparent to the consumer, since the color of the top piece 402 of the tread marker 400 matches the black of the surrounding tread 14 (FIG. 1). As the tread and tread markers wear, the wear line 429, as viewed in FIG. 7A section A-A and FIG. 7B section B-B, generally moves from right to left, and the yellow (or white) area increases, thereby providing the consumer with a good instantaneous indication of how soon the tires will need to be replaced. As in the first and second embodiments, the yellow circular areas may also serve to indicate to the consumer that uneven tire wear is occurring and that preventive maintenance such as wheel alignment, balancing, or tire pressure adjustment should be made to both increase the life of the tire, as well as provide a greater level of safety to the consumer.

Alternately, top piece may be of a color that contrasts with that of the surrounding tire tread to give a visual indication fo the percent of life remaining, given by the equation:

% life remaining=(d−Xᵢ)/d*100

As the tire reaches the end of its effective life, the second wear region 422 (shown in FIG. 7D) is reached, and is visible to a consumer as the cross hatched area of FIG. 7C, section C-C. When the exemplary color scheme is used, the consumer will be alerted to a tire in need of replacement when he or she sees bright red circular areas that have replaced the yellow (or white) areas on the tread of the tire. At this point the tire is in need of immediate replacement.

In a related embodiment, not illustrated, the interface between base 406 and middle piece 404 is angled similarly as the interface between middle piece 404 and top piece 402, above, and the interface between the middle piece 404 and top piece 402 either remains angled, as shown above, or may be perpendicular to the tread marker axis. In this embodiment, for example, using the exemplary color scheme, if the two interfaces are at the same angle to the axis in the longitudinal section shown, the middle piece 404 would be an angled slice of yellow (or white) material. As this related embodiment wears down, the same progression of the wear line 429 would occur, except now there would be two of them. The consumer would initially see the black indicator, then as the first wear line 429 transverses from left to right, a second wear line (not shown), which is the exposed interface between the yellow middle piece 404 and the red base 406, would follow wear line 429 across the face of the exposed wear surface. For example, a consumer would observe a yellow band followed by a red area traversing across the wear surface as the tread marker wears down, and the end of life condition would occur once the yellow area has worn away, and a red circular area is seen by the consumer.

Alternately, in a simpler embodiment, middle piece 404 and base 406 comprise one piece, colored red for example, and top piece 402 could be black so that only one colored portion is used to indicate the progression of the tire's lifetime.

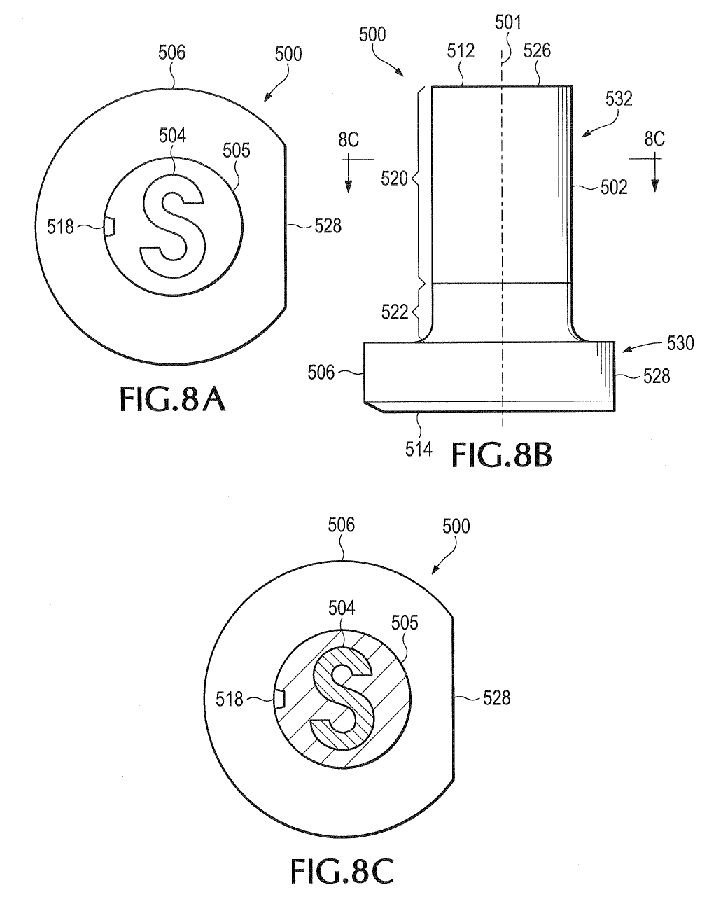

FIG. 8B is a side view of a fourth embodiment of a tread marker 500. FIG. 8A is a top view of the fourth embodiment of a tread marker 500. FIG. 8C is a lateral sectional view of the fourth embodiment of a tread marker 500. The fourth embodiment comprises components configured generally in a stack. Two components are shown here, though any number could be used. Here, for exemplary purposes, there is shown a thread marker comprising a generally cylindrical top piece 502, and a base 506. The materials and construction of this embodiment of a thread marker are similar to that mentioned above with respect to the above embodiments. However, the manufacture of the top piece 502 utilizes additional manufacturing methods. Top piece 502 comprises indicia 504, comprising an icon, symbol or source of manufacture, distribution, or point of consumer purchase, that runs along the axis 501 of top piece 502, with a surrounding matrix 505. Top piece 502 may be made, for example, by through such manufacturing methods as insert molding, overlay molding, coextrusion, overjacket extrusion, serial extrusion processes, or the like. In one embodiment, an extrusion through dual dies is made. The first die has the shape of indicia 504 and the second die has a generally circular shape whose diameter is substantially that of top piece 502, and includes indent 518. A long rod of material is made, having a cross section of the crosshatched regions of FIG. 8C. The rod is subsequently cut to length, each piece is rotationally located with respect to base 506, and the two pieces are fixed together through sonic welding, or through another welding, solvent bonding, or adhesive bonding technique.

Also similar to the above embodiments, wear surface 526 initially starts at the tread marker's outer surface 512, and progressively moves toward the tread marker's inner surface 514 as the tire wears. This embodiment also utilizes a rotational locator feature that is used by assembly equipment to automatically align all of the tread markers inserted into a tire so that they all face the same direction from the perspective of a viewer looking at the tire's outer surface. One rotational locator feature illustrated is a flat portion 528 located on the outside perimeter of the head portion 530 of the tread marker 500. Another rotational locator feature illustrated is an indent 518 located on the outside perimeter of the body portion 532 of the tread marker 500. Indent 518 is used to rotationally align the top piece 502 with the base 506 during tread marker 500 assembly and/or to rotationally align the assembled tread marker 500 with a tangent of the outer diameter of tire tread during the insertion of the tread markers into the tire. Other rotational locator features located on the head portion 530 or the body portion 532, such as one or more notches or indents, or external features, such as one or more small protruding nubs or fingers, could be used with equal effectiveness.

In use, as the tread marker wears away along with the tire tread, this embodiment has two distinctive wear regions (520 and 522 as shown in FIG. 8B). When a tire having these tread markers is used, wear occurs in the first wear region 520, and is visible to a consumer as the cross hatched areas of FIG. 8C, lateral cross section C-C. Materials of any color may be used for the components. In one embodiment, the indicia of source 504 and surrounding matrix 505 of top piece 502 are of contrasting colors, with the matrix 505 perhaps matching the color of the surrounding tread. An exemplary color of base 506 is bright red, and indicates to the consumer a tire's end of life.

As the tire reaches the end of its effective life, the second wear region 522 is reached, and the indicia of source 504 is no longer observable. The disappearance of the indicia of source 504, could alternately be positioned to indicate the expiration of one or more of the manufacturer's warrantees. Such an embodiment may have an additional component disposed between the top piece 502 and the base 506.

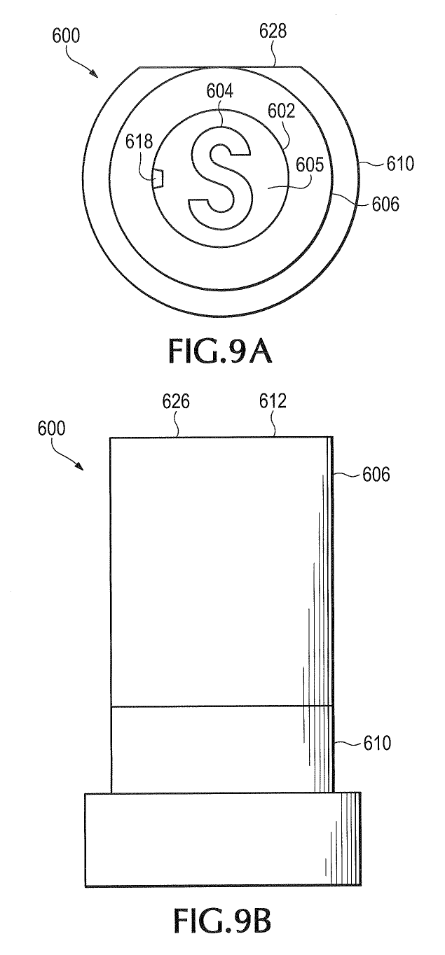

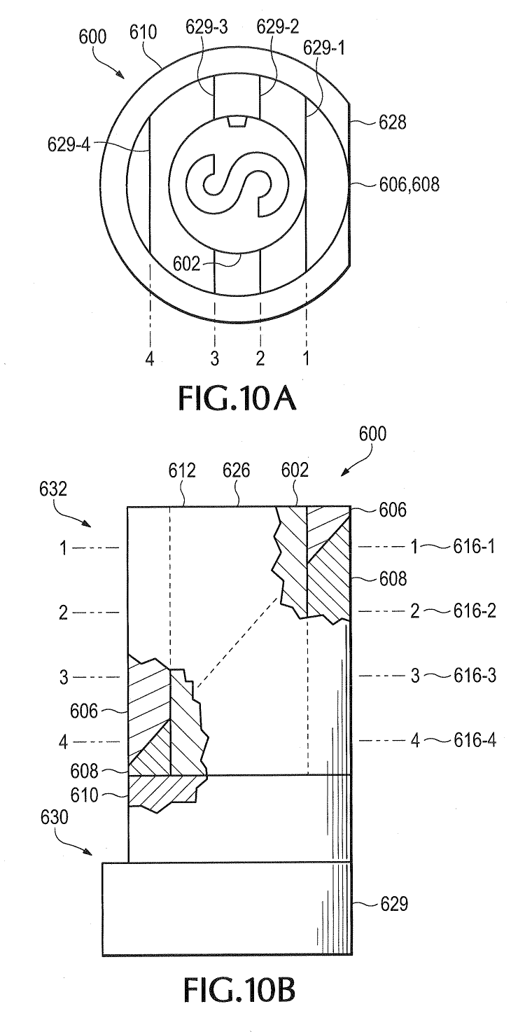

Turning now to FIGS. 9A-B, there are shown a top view and a front view of a fifth embodiment of a tread marker 600. The fifth embodiment, in general, comprises a combination of the third and fourth embodiments. The tread marker 600 includes a central piece 602 that comprises indicia of source 604 and matrix 605, similar to top piece 502 of the fourth embodiment, a top annular piece 606, analogous with the angled top piece 402 of the third embodiment, a middle annular piece 608 (shown in FIG. 10 A-B), analogous with the angled middle piece 404 of the third embodiment, and a base 610. The materials and construction of this embodiment of a thread marker are similar to that mentioned above with respect to a above embodiments, as is the exemplary color scheme of black-yellow(or white)-red for the indicator elements. Other colors could be substituted for each component. Any colors may be chosen for the central piece 602.

Turning now to FIGS. 1A-B, there is shown a side view of the fifth embodiment of the tread marker 600 with partial sectional sections to show the interface between the top annular piece 606 and the middle annular piece 608. In addition, an exemplary progression of wear lines on sequential wear surfaces is shown in FIG. 10A (1-4). Each sequentially numbered line indicates the location of the wear line as the tread marker 600 progressively wears as indicated by correspondingly numbered wear surfaces shown on edge in the side view below (616-1 through 616-4).

In use, as tread marker 600 wears, the wear line 629, that occurs on wear surface 626 as the result of the angular interface between the top annular piece 606 and the middle annular piece 608 become exposed, moves from right to left in FIG. 10A, progressing from 1 to 2 to 3 to 4 (629-1 through 629-4), for example. If the exemplary color scheme is used, the annular area to the right of the wear line is yellow and that to the left is a shade of black that matches the tire tread color. As in the third embodiment, above, this progression may give a high-resolution visual indication that shows the percentage of life spent (or remaining) in the tire's life, which may be calculated by the equations given above. FIGS. 10A-B show the interface between the top annular piece 606 and the middle annular piece 608 as comprising two adjoining planar surfaces; alternately, the interfaces between the top annular piece 606 and the middle annular piece 608 may be stair-stepped to yield the same general result, while perhaps providing for more reliable manufacture. If the exemplary color scheme is used, once the wear surface 626 reaches the base 610, the consumer sees the wear surface change from a view of the central piece 602, and its indicia of source, surrounded by the annular yellow/black area, which had become all yellow, to an all-red area that indicates that it is time to replace the tire. Four components are shown here, though any number could be used with multiply angled interfaces therebetween.

This embodiment also utilizes rotational locator features that may be used by assembly equipment to automatically align the tread markers with the surface of the tire so that upon insertion they all face the same direction from the perspective of a viewer looking at the tire's outer surface. The first exemplary rotational locator feature is a flat portion 628 located on the outside perimeter of the head portion 630 of the tread marker 600. A second exemplary rotational locator feature is a central piece rotational indexing feature 618, located in central piece 602, which may additionally be used in aligning the central portion 606 with the annular portions 606 and 608 during assembly of tread marker 600. Other rotational locator features located on the head portion 630 or the body portion 632, such as one or more notches or indents, or external features, such as one or more small protruding nubs or fingers, could be used with equal effectiveness.

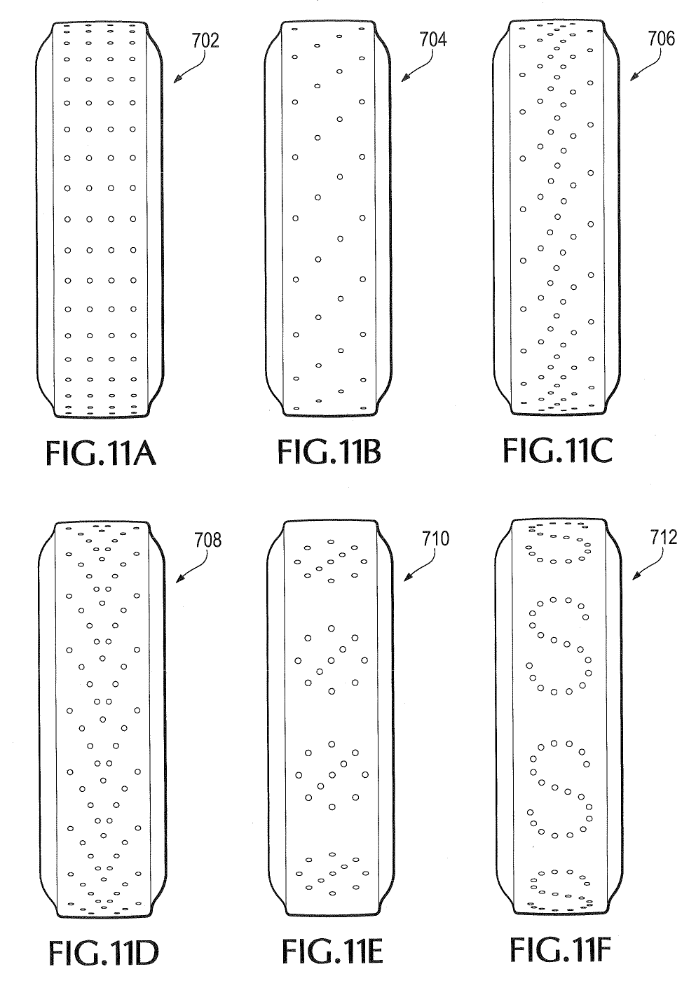

FIG. 11A-F shows exemplary arrangements of tread markers in a tire tread which yield visually attractive tread marker patterns both when a vehicle having such tires is stationary, as well as when it is moving. FIG. 11A shows an orthogonal pattern 702 distributed around the perimeter of a tire. FIG. 11B shows a diagonal pattern 704 distributed around the perimeter of a tire. FIG. 11C shows a serpentine pattern 706 distributed around the perimeter of a tire. FIG. 11D shows a V-shaped pattern 708 distributed around the perimeter of a tire. FIG. 11E shows a “not” symbol (ø) pattern 710 distributed around the perimeter of a tire. This pattern works particularly well in embodiments using the exemplary color scheme, where each tread marker shows a bright red section when the tire reaches the end of its effective life. When the consumer sees a red “not” symbol (ø) he or she knows, as do others, that the tire needs to be replaced. FIG. 11 F shows indicia of source of manufacture, distribution, or point of consumer purchase pattern 712 distributed around the perimeter of a tire.

It should be understood that even though these numerous characteristics and advantages of various embodiments have been set forth in the foregoing description, together with details of the structure and function of the embodiments, the disclosure is illustrative only, and changes may be made in detail, especially in matters of shape, size and arrangement of parts within the principals of the invention(s) claimed in the appended claims to the full extent indicated by the broad general meaning of the terms in that the appended claims are expressed.

What is claimed is:

1. A visual marker for a tire tread, comprising:
a top portion having a first color; and
a bottom portion having a second color, where the second color is configured to provide an indication that the tire has reached a tire replacement time.

2. The visual marker of claim 1,
to where the marker has a substantially cylindrical shaped body with an axis that runs through the top portion and the bottom portion; and
where the bottom portion contains a head portion of larger diameter than the body.

3. The visual marker of claim 1, further comprising:
a middle portion comprising a third color to indicate that the tire is approaching the tire replacement time.

4. The visual marker of claim 1, where the marker is adapted to be mounted in a blind hole in the tire tread at a predetermined depth, and where the first color substantially matches a color of the tire tread.

5. The visual marker of claim 1, where the marker comprises components manufactured by extrusion or injection molding.

6. The visual marker of claim 1, where the marker comprises polymeric components, and where the polymeric components include rubber compounds, polyurethanes, thermoplastics, cured materials, or combinations thereof.

7. A marker adapted to be inserted into a tread of a tire, comprising:
a rod-shaped body having an axis, a top surface and a bottom surface;
a first wear region within the marker having a first color and located axially from the outer surface to an interface; and
a second wear region within the marker having a second color and located below the interface;
where the second wear region provides a visual indication that a tire replacement time has been reached.

8. The marker of claim 7, where the first wear region provides an indication of a percentage of tread life expended as the marker wears from the top surface to the interface.

9. The marker of claim 7, where the first wear region includes an icon, symbol, or indicia of source.

10. The marker of claim 7, further comprising an intermediate wear region located between the first wear region and the second wear region, where the intermediate wear region comprises a third color to indicate that the tire is approaching the tire replacement time.

11. The marker of claim 7, where a wear region includes a sensor material that is progressively worn away, where the sensor material communicates a signal to an embedded radio-frequency identification chip that transmits an indication of tread wear condition to a receiver that is in communication with a vehicle's instrument panel to give a readout of an amount of tire life remaining.

12. The marker of claim 7, further comprising an annular outer layer, where at least a portion of the rod-shaped body comprises a central portion whose lateral cross-section includes an icon, symbol, or indicia of a tires' source of manufacture, distribution, or point of purchase, and where the annular outer layer is configured to provide an indication of a percentage of tire life spent as the tread of the tire wears.

13. A method for making a visual marker for tire tread, comprising:
extruding, along an axis, a rod of polymeric material having a lateral cross sectional area and a perimeter, where the cross sectional area comprises a first area of a first color and a second area of a second color, where the first color is different than the second color, and where the rod perimeter has an index feature for rotational alignment;
cutting the extruded rod into lengths;
rotationally aligning a length of rod with a base piece; and
fixing the length of rod to the base piece.

14. The method of claim 13, where the first area forms the shape of an icon, symbol, or indicia of source of manufacture, distribution, or point of purchase.

15. The method of claim 13, where the fixing comprises sonic welding of the length of rod to the base piece, and where the rod and base piece comprise thermoplastic components including acrylonitrile butadiene styrene, nylon, polyolefin, or combinations thereof.

16. A method of inserting a rotationally indexed tread marker into a tread of a tire, comprising:
means for expanding a blind hole molded into the tread of the tire, where the blind hole has an opening located on an outer circumference of the tread surface of the tire;
means for rotating the rotationally indexed tread marker about a rotationally indexed tread marker axis;
means for aligning an indexing feature of the rotationally indexed tread marker with the tangent of the outer circumference of the tread surface of the tire at the blind hole opening;
means for inserting the rotationally indexed tread marker into the tread of a tire, where the blind hole extends radially into the tire tread, and where the rotationally indexed tread marker is inserted to a predetermined depth in the blind hole.

17. The method of claim 16, where the rotationally indexed tread marker further comprises:
a rod-shaped body having an axis, a top surface, and a bottom surface;
a first wear region within the marker having a first color and located axially from the outer surface to an interface; and
a second wear region within the marker having a second color and located below the interface, where the second wear region provides a visual indication that a tire replacement time has been reached.

18. The method of claim 17, where the first wear region provides an indication of a percentage of tread life expended as the marker wears from the top surface to the interface.

19. The method of claim 17, where the first wear region includes an icon, symbol, or indicia of source.

20. A tire for a vehicle, comprising:
a tread portion of a first color located between an inner and an outer surface, where the inner surface is generally cylindrical, where the outer surface is generally cylindrical, where the inner surface and the outer surface are substantially concentric, and where the inner surface is located at a radius smaller than the outer surface;
a plurality of cavities radially extending partially into the tread portion from the outer surface toward the inner surface to a predetermined depth, and where each said cavity has an axis extending in the radial direction; and
a plurality of markers, where each said marker has an axis and resides within a corresponding cavity of the plurality of cavities, where the axis of each said marker coincides with the axis of the corresponding cavity, where the marker includes at least two longitudinal sections, and where the marker includes a second color.

21. A method for manufacturing a tire for a vehicle, comprising:
molding a tire, where the tire has a tread portion located between an inner and an outer surface, where the inner surface is generally cylindrical, where the outer surface is generally cylindrical, where the inner surface and the outer surface are substantially concentric, and where the inner surface is located at a radius smaller than the outer surface where the tread portion of the tire has a plurality of cavities radially extending partially into the tread portion from the outer surface toward the inner surface, and where each said cavity has an axis extending in the radial direction;
curing the tire at an elevated temperature;
cooling the tire; and
inserting into each cavity a pre-molded marker, where the marker has an axis substantially aligned with the cavity axis, where the marker includes a top portion having a first color; and
a bottom portion having a second color, where the second color is configured to provide an indication that the tire has reached a tire replacement time.

21. The method of claim 20, where the inserting comprises the insertion of the pre-molded marker with a tire stud insertion tool.

22. The method of claim 20, where the marker further includes a rotationally indexing feature, and where the rotationally indexing feature is aligned with a tangent of the outer surface of the tread.
